(19) United States
(12) Patent Application Publication
(10) Pub. No.: US 2014/0280460 A1
(43) Pub. Date: Sep. 18, 2014

(54) SYSTEMS, METHODS AND APPARATUS FOR MANAGING AND DISPLAYING ELECTRONIC MESSAGES

(71) Applicants: Deven Scott NEMER, Thousand Oaks, CA (US); Gregory FRIEDMAN, Los Angeles, CA (US)

(72) Inventors: Deven Scott NEMER, Thousand Oaks, CA (US); Gregory FRIEDMAN, Los Angeles, CA (US)

(73) Assignee: NEVADA FUNDING GROUP INC.

(21) Appl. No.: 14/209,423

(22) Filed: Mar. 13, 2014

Related U.S. Application Data
(60) Provisional application No. 61/792,750, filed on Mar. 15, 2013.

(51) Int. Cl. H04L 12/58

(52) U.S. Cl. CPC H04L 51/36
USPC 709/202; 707/722; 709/217; 709/219

(57) ABSTRACT

A plurality of messages are retrieved from storage in response to a request received from a user device. The plurality of stored messages include a first message of a first type and a second message of a second type. For example, the first message may be a chat message and the second message may be an email message. The user device is caused to display the plurality of messages in a first region of a display. In response to selections of respective messages from among the plurality of messages, the user device is caused to display, simultaneously, the plurality of messages in the first region of the display and content associated with each selected message in a second region of the display. In one embodiment, messages and requests are transmitted via a websocket connection.

This application claims priority from U.S. Provisional Application No. 61/792,750, filed Mar. 15, 2013, which is hereby incorporated by reference herein in its entirety.

### TECHNICAL FIELD

This specification relates generally to systems and methods for conducting electronic messaging, and more particularly to systems and methods for managing and displaying electronic messages.

### BACKGROUND

As access to the Internet increases, the use and importance of electronic messaging systems grows. Many different types of electronic messages and electronic messaging systems have been developed and are in common use, including email messaging systems, chat messaging systems, text messaging systems, etc. Typically, messaging systems for different types of messages function independently of one another. For example, existing email messaging systems allow a user to send and receive email messages, but cannot handle chat messages or text messages; existing chat messaging systems allow users to exchange chat messages but cannot handle email messages or text messages, etc. There is a need for improved messaging systems that merge the different functionalities of different messaging systems and which are capable of handling different message types.

### SUMMARY

In accordance with an embodiment, a method of providing information is provided. A plurality of messages are retrieved from storage in response to a request received from a user device. The plurality of stored messages include a first message of a first type and a second message of a second type. The user device is caused to display the plurality of messages in a first region of a display. In response to selections of respective messages from among the plurality of messages, the user device is caused to display, simultaneously, the plurality of messages in the first region of the display and content associated with each selected message in a second region of the display.

In one embodiment, the first message of the first type comprises a chat message, and the second message of the second type comprises an email message.

In another embodiment, a websocket connection is established between a server and the user device. The plurality of messages are provided to the user device via the websocket connection. In another embodiment, the plurality of messages are streamed to the user device via the websocket connection.

In accordance with another embodiment, a method of providing information via a network is provided. A full-duplex communication channel is established between a server and a user device. A plurality of messages are retrieved from storage based on a request received from the user device. The plurality of messages are provided to the user device via the full-duplex communication channel. The user device is caused to display the plurality of messages in a first webview. A selection of a particular message among the plurality of messages is received from the user device, via the fill-duplex communication channel. Content associated with the particular message is provided to the user device, via the via the full-duplex communication channel. The user device is caused to display simultaneously the plurality of messages in the first webview and the content in a second webview.

In one embodiment, the full-duplex communication channel comprises a websocket connection.

In another embodiment, a WebSocket handshake request is received from the user device. A WebSocket handshake response is transmitted to the user device.

In another embodiment, communications are conducted via the full-duplex communication channel using Transmission Control Protocol (TCP) port 80.

In another embodiment, providing the plurality of messages to the user device via the full-duplex communication channel further comprises streaming the plurality of messages to the user device via the full-duplex communication channel.

In another embodiment, a second selection of a second particular message among the plurality of messages is received from the user device, via the full-duplex communication channel. Second content associated with the second particular message is provided to the user device, via the via the full-duplex communication channel. The user device is caused to display simultaneously the plurality of messages in the first webview and the second content in the second webview.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system in accordance with an embodiment;

FIG. 2 shows components of a network manager in accordance with an embodiment;

FIG. 3 shows components of a messaging service in accordance with an embodiment;

FIG. 4 shows a user login page in accordance with an embodiment;

FIG. 5 shows a network manager and a plurality of user devices connected by respective websocket connections;

FIG. 6A is a flowchart of a method of allowing a user access to a plurality of messages in accordance with an embodiment;

FIG. 6B shows a menu page in accordance with an embodiment;

FIG. 7 shows a message page on which a plurality of messages are displayed in accordance with an embodiment;

FIG. 8 shows a message page on which a plurality of messages are displayed in accordance with an embodiment;

FIG. 9 shows a message page on which a plurality of messages are displayed in accordance with an embodiment;

FIG. 10 shows a message page on which a plurality of messages are displayed in accordance with an embodiment;

FIG. 11 shows a message page on which a plurality of messages are displayed in accordance with an embodiment;

FIG. 12 shows a message page on which a plurality of messages are displayed in accordance with an embodiment;

FIG. 13A is a flowchart of a method of providing access to messages and displaying the messages in accordance with an embodiment;

FIG. 13B shows a message box and a message type selection box in accordance with an embodiment;

FIG. 13C is a flowchart of a method of receiving and displaying urgent messages in accordance with an embodiment;

FIG. 13D illustrates a system and method for handling urgent messages in accordance with an embodiment;

FIG. 13E illustrates a system and method for handling urgent messages in accordance with an embodiment;

FIG. 13F illustrates a system and method for handling urgent messages in accordance with an embodiment;

FIG. 13G illustrates a system and method of organizing and filtering messages in accordance with an embodiment;

FIG. 13H shows a page comprising a chat view in accordance with an embodiment;

FIG. 13I shows a page comprising an email view in accordance with an embodiment;

FIG. 13J shows a system and method for blocking messages in accordance with an embodiment;

FIG. 13K shows a system and method for repurposing messages in accordance with an embodiment;

FIG. 13L shows a system and method for screen sharing in accordance with an embodiment;

FIG. 13M shows a first webview displaying a web page and a second webview displaying messages in accordance with an embodiment; and

FIG. 14 is a high-level block diagram of an exemplary computer that may be used to implement certain embodiments.

### DETAILED DESCRIPTION

FIG. 1 shows a communication system in accordance with an embodiment. Communication system 100 comprises a network 105, a network manager 135, and a messaging service 145. Communication system 100 also comprises a plurality of user devices 160-A, 160-B, 160-C, etc.

For convenience, the term “user device 160” is sometimes used herein to refer to any one of user devices 160-A, 160-B, 160-C, etc. Accordingly, any discussion herein referring to “user device 160” is equally applicable to each of user devices 160-A, 160-B, 160-C, etc. Communication system 100 may include more or fewer than three user devices.

In the exemplary embodiment of FIG. 1, network 105 is the Internet. In other embodiments, network 105 may comprise one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 105 may comprise a combination of different types of networks.

User device 160 may be any device that enables a user to communicate via network 105. User device 160 may be connected to network 105 through a direct (wired) link, or wirelessly. In one embodiment, user device 160 may include an Internet browser that enables a user to access content via the Internet. In one embodiment, user device 160 has a display screen for displaying information. For example, user device 160 may be a personal computer, a laptop computer, a workstation, a mainframe computer, etc. Alternatively, user device 160 may be a mobile communication device such as a wireless phone, a personal digital assistant, etc. Other devices may be used.

Network manager 135 controls access to content and services. FIG. 2 shows components of network manager 135 in accordance with an embodiment. Network manager 135 includes a controller 210, a user registration & login module 220, a websocket module 225, and a storage 230. Controller 210 orchestrates the operation of other components of network manager 135. User registration & login module 220 manages the registration and login of a user prior to the user being permitted to access content and services. Storage 230 is used from time to time by other components of network manager 135 to store various types of data. For example, in the illustrative embodiment of FIG. 2, a user registration database 265 containing usernames, passwords, and other information relating to various users is stored in storage 230. Network manager 135 may include other components not shown in FIG. 2.

Websocket module 225 from time to time establishes a websocket connection between network manager 135 and another device in communication system 100. As used herein, the term “websocket connection” refers to a connection established in accordance with the WebSocket protocol, which provides full-duplex communication channels over a single TCP connection. The WebSocket protocol was standardized by the IETF as RFC 6455 in 2011.

In another embodiment, a WebSocket API in Web IDL is used.

Communications conducted via a websocket connection are different from HTTP communications, because unlike HTTP, WebSocket provides for full-duplex communication. HTTP uses a request-response structure in which a client transmits a request to a server, and the server transmits a response after the complete request has been transmitted. In contrast, after an initial handshake, WebSocket does not require repeated requests and responses for each communication. Additionally, WebSocket enables streams of messages on top of TCP. Secure versions of the WebSocket protocol have been implemented for a variety of different browsers.

To establish a websocket connection, a client sends a WebSocket handshake request, in a well-known format, and the server sends a WebSocket handshake response, in a well-known format. The handshake resembles HTTP so that servers can handle HTTP connections as well as websocket connections on the same port. However, the specific fields involved, and activity after the handshake, do not conform to the HTTP protocol.

In one embodiment, websocket communications are conducted using Transmission Control Protocol (TCP) port 80.

Once a websocket connection is established, the client and server can send WebSocket data or text frames back and forth in full-duplex mode. The data is minimally framed, with a small header followed by payload. WebSocket transmissions are described as “messages,” where a single message can optionally be split across several data frames. This allows for sending of messages where initial data is available but the complete length of the message is unknown.

Messaging service 145 provides a plurality of different types of messaging services to users, including an email messaging service, a chat messaging service, a text messaging service, etc. FIG. 3 shows components of messaging service 145 in accordance with an embodiment. Messaging service 145 comprises a messaging module 310 and a storage 320. Messaging module 310 provides messaging services to users. Messaging module 310 comprises functionality to receive, process, and transmit a variety of different types of messages. Thus, messaging module 310 comprises functionality to send and receive email messages, functionality to send and receive chat messages, functionality to send and receive text messages, etc. Storage 320 is used to store various types of data. For example, messaging module 310 stores various types of messages in messages database 375 within storage 320.

In an illustrative embodiment, a user named Joe, employing user device 160-A, accesses a website maintained by network manager 135. For example, the user may utilize a browser application (not shown) residing and operating on user device 160-A to access the website. Upon accessing the website, user registration & login module 220 (of network manager 135) may provide a user login page such as that shown in FIG. 4. User login page 400 includes a username field 410 and a password field 420. After the user enters a valid username and password, and is authenticated, controller 210 (of network manager 135) instructs websocket module 225 to establish a websocket connection between network manager 135 and user device 160-A. In response, websocket module 225 establishes a websocket connection between network manager 135 and user device 160-A. Referring to FIG. 5, a websocket connection 510 is established between network manager 135 and user device 160-A.

In one embodiment, network manager 135 is capable of establishing and maintaining a plurality of separate websocket connections simultaneously between network manager 135 and a plurality of user devices. FIG. 5 shows network manager 135 and a plurality of user devices 160-A, 160-B, and 160-C. While websocket connection 510 is maintained between network manager 135 and user device 160-A, a second websocket connection 520 is established between network manager 135 and user device 160-B, and a third websocket connection 530 is established between network manager 135 and user device 160-C.

In one embodiment, network manager 135 manages communications between a user device 160 and another component of communication system 100. For example, a request for data sent by user device 160 to messaging service 145 is transmitted via websocket connection 510 to network manager 135, which forwards the request to messaging service 145. Data transmitted by messaging service 145 to user device 160 in response to the request is transmitted to network manager 135 and then to user device 160 via websocket connection 510.

In accordance with an embodiment, network manager 135 allows a user to access and view a plurality of messages of different types via a websocket connection. FIG. 6A is a flowchart of a method of allowing a user access to a plurality of messages in accordance with an embodiment. At step 602, a full-duplex communication channel is established between a server and a user device. In the illustrative embodiment discussed above, network manager 135 establishes websocket connection 510 between network manager 135 and user device 160-A.

At step 604, a plurality of messages are retrieved from a storage based on a request received from the user device. In the illustrative embodiment, controller 210 (of network manager 135) causes the browser on user device 160-A to display a menu page such as that shown in FIG. 6B that indicates one or more products and/or services available via the website. Menu page 600 presents a plurality of selections including a search button 610, a games button 620, a messages button 630, a store button 640, a music button 650, and a photos button 660. Other selections may be included. In the illustrative embodiment, Joe, the user of user device 160-A, wishes to review messages that he has received from other users. Accordingly, Joe (the user) selects messages button 630. Network manager 135 receives the user's selection and transmits the user's request to messaging service 145.

At step 605, the plurality of messages are provided to the user device via the full-duplex communication channel. In response to the user's selection, messaging service 145 retrieves one or more messages from storage and provides them for display on user device 160-A. At step 606, the user device is caused to display the plurality of messages in a first webview. Specifically, messaging service 145 causes user device 160-A to display a message page such as that shown in FIG. 7. Message page 700 includes a first region 702 on the left side of the display, comprising a list 711 of messages, and a second region 704, in the center portion and right side of the display, in which selected messages are displayed. List 711 comprises a plurality of message tabs; the message tabs may all be associated with a single type of message (such as email messages) or may be associated with different types of messages such as email messages, chat messages, text messages, etc. In the illustrative embodiment, list 711 includes a message tab 721 associated with a first chat message from Bob, a message tab 722 associated with a second chat message from Bob, a message tab 723 associated with a chat message from Joe (the user), and a message tab 724 associated with an email message from Susan.

Region 704 displays message boxes showing the contents of selected messages. In the illustrative embodiment, messages sent by other individuals (and received by the user) are displayed in the left-hand portion of region 704; messages sent by the user to others are displayed in the right-hand portion of region 704. Thus, region 704 displays a message box 731 (corresponding to message tab 721) containing a first chat message from Bob, and a message box 733 (corresponding to message tab 722) containing a second chat message from Bob, on the left side of region 704, and a message box 735 (corresponding to message tab 723) containing a chat message from Joe (the user), on the right side of region 704. Message page 700 also comprises a scroll bar 770 which may be used to scroll down and examine, within region 704, additional message boxes associated with other messages.

Message page 700 also comprises a third region 755 at the bottom of the display; region 755 includes a text box 756 in which a user may enter text for the purpose of creating a chat message. After entering text, the user may select a SEND option 759 to transmit the chat message. In the illustrative embodiment, when a chat message is entered and sent, the message is transmitted via websocket connection 510, and forwarded to messaging service 145. Messaging service 145 then stores the message. The message transmitted is also displayed in region 704. All or a portion of the contents of the message is transmitted to user device 160-A via websocket connection 510.

In one embodiment, each region 702, 704, 755 comprises a respective webview. Thus, for example, page 700 may comprise a first webview 702, a second webview 704 and a third webview 755.

In the illustrative embodiment, after reviewing the messages displayed in region 704, Joe (the user) wishes to view more messages. The user accordingly moves scroll bar 770 down the page. In response, messaging service 145 causes additional messages to appear on the display, as shown in FIG. 8. Now message box 735 and a portion of message box 733 are displayed, and a message box 815 (corresponding to message tab 724) containing an email message 816 from Susan is displayed in region 704. Message box 815 also includes options associated with common email-related functions, including a REPLY button 818, a FORWARD button 819, etc.

The user reads the email message in message box 815 and, wishing to reply, selects REPLY button 818. In response, messaging service 145 uses known techniques to enable the user to compose and send a reply email message to Susan. The reply email message is displayed in a message box 942 on the right side of region 704, as shown in FIG. 9.

Suppose that at a later date Joe (the user) again accesses and views his messages. In the interim, Joe has received a number of new messages of different types. Referring to FIG. 10, list 711 displayed in region 702 now comprises message tabs 1021, 1022, 1023, 1024, 1025, 1026, 1027, and 1028. Several message boxes are displayed in region 704, including a message box 1031 containing an email from Bob (corresponding to message tab 1023), a message box 1033 containing a chat message from Bob (corresponding to message tab 1024), and a message box 1035 containing a chat message from Joe (corresponding to message tab 1025).

In one embodiment, because of the limited size of the message boxes, a message box may show only a limited amount of the contents of a message.

Joe (the user) wishes to view in further detail the contents of the email message from Bob shown in message box 1031 (which corresponds to message tab 1023). Joe accordingly selects message tab 1023 by clicking on tab 1023.

At step 607, a selection of a particular message among the plurality of messages is received from the user device, via the full-duplex communication channel. In the illustrative embodiment, the user's selection of message tab 1023 is transmitted via websocket connection 510. Messaging server 145 receives the user's selection.

At step 608, content associated with the particular message is provided to the user device, via the via the full-duplex communication channel. In response to the user's selection, messaging server 145 transmits the contents of the email message from Bob (corresponding to message box 1023) to user device 160-A via websocket connection 510. At step 609, the user device is caused to display simultaneously the plurality of messages in the first webview and the content in a second webview. Messaging server 145 causes user device 160-A to display the contents of the email from Bob in region 704, as shown in FIG. 11. Message tab 1023 is now shaded, indicating that the contents of the corresponding message is displayed in region 704

Joe (the user) now wishes to view the email message from Nancy represented by message tab 1026 (displayed in region 702). Joe accordingly selects message tab 1026 by clicking on tab 1026. In response to the user's selection, messaging server 145 retrieves the content of the corresponding email message and causes user device 160-A to display the contents of the email message in region 704, as shown in FIG. 12. Message tab 1026 is now shaded.

In one embodiment, the user's selection of the message tab is transmitted via websocket connection 510. Similarly, the contents of the email message associated with message tab 1026 are transmitted to user device 160-A via websocket connection 510.

Advantageously, a user may quickly obtain and view (e.g., in region 704) the content associated with different messages listed in region 702 by selecting the respective message tabs. Because network manager 135 maintains a websocket connection with user device 160-A, the content associated with each selected message is transmitted to user device 160-A without the need, for example, to complete a request-response procedure as required by the HTTL protocol each time a different result is selected.

FIG. 13A is a flowchart of a method of providing access to messages and displaying the messages in accordance with an embodiment. At step 1310, a plurality of messages are retrieved from storage in response to a request received from a user device, wherein the plurality of stored messages comprise a first message of a first type and a second message of a second type. At step 1320, the user device is caused to display the plurality of messages in a first region of a display. At step 1330, in response to selections of respective messages from among the plurality of messages, the user device is caused to display, simultaneously, the plurality of messages in the first region of the display and content associated with each selected message in a second region of the display.

In another embodiment, systems and methods described herein may be implemented to handle other messaging types including call logs, voicemails, self destructing messages, urgent messages, chat messages, email messages, text messages (SMS & MMS), etc. FIG. 13B shows a message box 2101 that may be displayed on a user device 160. When a user selects a message type option 2102, a message type selection box 2103 is displayed; the message type selection box 2103 includes plurality of message type options including options for text (SMS & MMS), chat, email, call log, voicemails, urgent message, self-destruct message, etc. Depending on the user's selection of a message type messaging service 145 enables the user to compose and send a message of the selected type.

In another embodiment, a person sending a message may choose how the message is sent, but the receiver can also choose how it is received.

FIG. 13C is a flowchart of a method of receiving and displaying messages is provided. At step 1360, an electronic message addressed to a receiving party and marked as urgent is received from a sending party. At step 1370, a contacts list associated with the receiving party is accessed, and a folder associated with the sending party is identified within the contacts list. At step 1380, a parameter associated with the folder is examined, the parameter indicating whether or not an urgent message requires a pop-up message. At step 1390, a pop-up message is displayed if the parameter indicates that an urgent message requires a pop-up message.

In an illustrative embodiment illustrated in FIG. 13D, a first person sends a message marked urgent to a first friend. Urgent message 2202 is displayed on a page 2203 displayed on the first user's device. The first friend stored the first person's contact information in a folder for which the settings are left in default mode. Default mode requires that when an urgent message is received, a pop-up message (stating that an urgent message has been received and optionally containing the content of the message) is to be displayed on the user device (regardless of the user's current activities). Accordingly, a pop-up message associated with the urgent message is displayed on the first friend's user device. Referring to FIG. 13D, a pop-up 2210 is displayed on a page 2213 displayed on the first friend's device. The first person later sends this same first friend another message that is not marked urgent. This message still is sent, but it only shows when the first friend accesses his inbox at the messaging service to see what messages he has received. Referring to FIG. 13D, non-urgent message 2232 is displayed on a page 2232 on the first person's user device. A page 2243 displayed on the first friend's device does not include a pop-up message; however, an indicator 2255 indicates that a message has been received.

In another embodiment illustrated in FIG. 13E, the first person sends an urgent message 2310 to a second friend. This second friend has placed the first person's contact information into a particular folder, and set as one of the settings 2320 for receiving messages for that particular folder as ignore urgent messages. Accordingly, the urgent message from the first person does not interrupt him with a pop-up. Referring to FIG. 13E, no pop-up message is displayed on a message screen 2330 displayed on the user device of the second friend, or on a browsing screen 2340 displayed on the user device of the second friend.

In another example illustrated in FIG. 13F, the first person sends an urgent message to a third friend. FIG. 13F shows a system and method of handling urgent messages in accordance with an embodiment. An urgent message 2410 is displayed on a page 2415 displayed on the first person's user device. The third friend has his settings 2420 set as specifying that if the third friend is online and displayed as online for a particular contact folder, then persons whose contact information is stored in that folder can send urgent messages to the third friend. i.e., if he is connected to the network and displayed as online for the sender of a message (users can set who they're displayed online for by defining a folder to show their online status), then when the sender sends him an urgent message it gives him the pop-up. Referring to FIG. 13F, a pop-up message 2430 is displayed on a page of the third friend's device 2435. But if he marks himself as offline, then it would be received like a regular message. A screen 2440 displayed on the third friend's device does not include a pop-up message. However, if he comes back online before he checks his messages through the messaging service, he will receive a pop up.

In another embodiment, an email-to-private message conversion function is provided. For example, when a new message is sent to another member it looks the same to the sender whether it's an email or a private message. There is an option to add a subject line, which is a defining characteristic between emails and private messages. However, the sender does not need to consider how the message is sent (email or Private message). The receiver of the message can choose to take incoming messages and have them all formatted as emails to view inside of the messaging module. The receiver can choose in a settings folder to have all of the messages forwarded to a different email account (in which case the receiver of that message can reply back within their email program and the original sender receives that reply back in the messaging module the same as if the reply were done within the messaging module. Advantageously, a decoupling is achieved as to how each user prefers to send/receive communication, so that every party can have a unique experience that works best for their workflow.

In another embodiment, messages are a converted to and from JSON. In JSON, a message is represented as a series of key values, which can contain every part needed to have the message and its meta data. Messages within the messaging service are all stored in JSON, even if it appears to look like a traditional email. When a message is sent out of our network whether that's through email, SMS, and API to a specific chat service, or any other method, the message is converted from JSON into the needed format before sending out, while a copy is stored in a database in JSON format. The same thing happens when a message is received from an outside network: the message comes into the messaging service, is converted to JSON, then delivered to the user. Even if both users are using a different service, such as email, the messages are converted into JSON to be stored and pooled together as shown in the views of the messaging module, then converted back to email format to satisfy the receiver's preference to receive the message in email format. Advantageously, the actual email addresses can be hidden as both users are simply sending a message that looks like it's solely within the network, even though both users chose to forward to their other email addresses.

In another embodiment, functionality for organization, filtration, and search of messages is provided. FIG. 13G shows a system and method of organizing and filtering messages in accordance with an embodiment. A user can choose, in a settings folder 2520, between a chat view option 2521 and an email view option 2522. In one embodiment, a chat view 2530 incorporates everything (all messages, including the message types described above) into one place, as described above, and organizes it based on the person that the user is communicating with. In addition, there are many sorting and filtering options. For example, the user can look at only other members that are online, only members that are within a predefined folder, only members that are starred/favorited (within a folder or within all contacts) and additional options. Within the webview that contains all of the messages, the user has an option to show messages within a specified timeframe, of just a specific message type, search for specific keywords and more. An email view 2540 is not based on the person, but on the subject of the message and all of the replies and forwards of that message. Unlike traditional email which looks at only the subject line to see if it's the same, the system can track the intent behind the message by tracking how the message originated. For example, supposing that a user is reading a message but wants to forward it to a colleague, but doesn't like the subject line as it is written so they change it. Because they clicked the forward button, it can be determined that the new message containing the forwarded content and the different subject name would both create a new thread and link to the messages from the original thread, since the forward button was clicked from within that original thread.

FIG. 13H shows a page 2610 comprising an email view. FIG. 13I shows a page 2710 comprising an email view.

In another embodiment illustrated in FIG. 13J, one-click blocking is provided. Based on Can-Spam laws most marketing emails require a way to opt-out, and many company go through elaborate measures to make this process difficult. Furthermore some people send individual emails that contain material that the receiver doesn't care about, but if it's not a large company there is no requirement to offer an unsubscribe option. With the messaging service described herein, the user may identify an individual from a list 2815 of individuals (e.g. from a contacts list, or a list of persons from whom messages have been received, etc.), and selects a “Block All Messages” option 2810. Consequently, messaging service 145 blocks and deletes all messages from that sender; there is no need to opt-out.

In another embodiment illustrated in FIG. 13K, a system and method are provided to repurpose a message. Messages can be converted to tasks within a tasks module where task fields are auto-populated with the meta data in the message and detected lists of items can be separated into multiple tasks. Messages may be stored as a note within a file module which is very useful while doing research and compiling information into one place. Messages can be repurposed into templates which can be used again later when sending other messages to other people. Messages can be marked as a referral attempt, which forwards the data (from the attempt to convert a lead into a sale) to the referral module so that statistics can be accumulated and progress measured. Messages can be forwarded to the calendar as appointments. Messages can be shared with others, in the form of just forwarding the message to another person or group, as well as in the form of a post on the user's profile, which is then shared based on the privacy settings into the news updates module to the people who are actively seeking these types of updates and have permission to view. The sharing with others mentioned in the previous sentence can also be done on behalf of a group/entity/organization. Referring to FIG. 13K, any one or more of messages, including 2901, 2902, 2903, may be repurposed by selecting a repurpose icon 2911. In response to a selection of icon 2911, messaging service 145 displays a repurposing menu 2915 comprising a plurality of repurposing options including task (2921), note (2922), template (2923), referral attempt (2924), appointment (2925), forward (2926), share as post on user profile (2927), etc. When the user selects an option messaging service 145 enables the user to repurpose the message accordingly.

In another embodiment illustrated in FIG. 13L, a screensharing functionality is provided. While chatting with other registered members of a network (there is no limit on group size), a member viewing screen 3010 can share the contents of the screen with the other members. In one embodiment, the exact HTML contents from the page the member is viewing is sent from the member's user device to a server 3020 (which may be, for example, network manager 135). Any other member who has been granted access to subscribe to the screenshare streaming data can view the exact HTML, scroll heights, and mouse movements on their own device. For example, other users may be granted access by providing a screen share identifier 3022, or password, etc. After the HTML is broadcast, the scroll height and x,y coordinates of the mouse are streamed to the server and relayed to the other devices. The server adds time stamping to the stream of events so that it could be replayed later by the user. The stream can also include an audio and/or video stream that would accompany the HTML being shared. Because it is the actual HTML being shown on the receiving user's device, other members may scroll around the page independently of the broadcasting member, but if they are in view-only mode (i.e., not trying to scroll or click on anything) the page scroll height will automatically adjust as the broadcaster emits a change event, such as a change in scroll height. In the event that a user does scroll away from the broadcast, upper and lower limit lines will be placed over the web content so that the viewer can see where the broadcaster is and if the viewer brings their own scroll height back to between the upper and lower limit lines of the broadcaster, then the viewer can go back to view only mode and the screen will adjust in scroll height accordingly. In the event that the two users have different screen sizes, analytics are used to determine a best guess on what the broadcaster is trying to focus on and focus on making that part of the screen visible on the viewers device, but the viewer, as mentioned above, may scroll to a different part of the page. The viewer may also click on HTML hyperlinks shown on the page and that will open the new page on a new tab, while the current tab will continue with the broadcast. Because the viewer is looking at the exact same HTML as the broadcaster, some content the broadcaster may be looking it is only permissible to that broadcaster. For example, the broadcaster may be logged into a service and looking at a page that is not publicly available. The HTML for that page is copied and sent out, but if a link is clicked on by a viewer, it's very likely the link would require a login from the viewer, since they are not the logged in broadcaster. Further, because the data could be sensitive and/or hidden behind username/password protections, none of the HTML is stored on the device and once the broadcaster navigates to a new page or ends the transmission, none of the previous HTML transmitted data is accessible and the back button is disabled. Also during this transmission, developer options which would typically let someone see the actual HTML seen in the page is disabled.

In another embodiment illustrated in FIG. 13M, information relating to one or more messages may be displayed while a user is using a browser application on user device 160. In the illustrative embodiment, page 4000 comprises a web page that may be displayed by a browser, for example. Page 4000 is displayed in a first webview on a left side of the display. A plurality of tabs 4021, 4022, 4023 are displayed in a second webview on a right side of the display. Each tab may show a summary of a message in the user's inbox, for example. The user may also open a message window 4010 which displays one or more messages and enables the user to create and send/post a message, as desired. Webview 4045 also includes several tabs 4061, 4062 associated with respective individuals; the user may, by selecting a tab associated with a particular person, obtain a list of messages received from (or sent to) that particular person.

In various embodiments, the method steps described herein, including the method steps described in FIGS. 6A and/or 13, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 6A and/or 13, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an exemplary computer that may be used to implement systems, apparatus and methods described herein is illustrated in FIG. 14. Computer 1400 includes a processor 1401 operatively coupled to a data storage device 1402 and a memory 1403. Processor 1401 controls the overall operation of computer 1400 by executing computer program instructions that define such operations. The computer program instructions may be stored in data storage device 1402, or other computer readable medium, and loaded into memory 1403 when execution of the computer program instructions is desired. Thus, the method steps of FIGS. 6A and/or 13 can be defined by the computer program instructions stored in memory 1403 and/or data storage device 1402 and controlled by the processor 1401 executing the computer program instructions. For example, the computer program instructions can be implemented as computer executable code programmed by one skilled in the art to perform an algorithm defined by the method steps of FIGS. 6A and/or 13. Accordingly, by executing the computer program instructions, the processor 1401 executes an algorithm defined by the method steps of FIGS. 6A and/or 13. Computer 1400 also includes one or more network interfaces 1404 for communicating with other devices via a network. Computer 1400 also includes one or more input/output devices 1405 that enable user interaction with computer 1400 (e.g., display, keyboard, mouse, speakers, buttons, etc.).

Processor 1401 may include both general and special purpose microprocessors, and may be the sole processor or one of multiple processors of computer 1400. Processor 1401 may include one or more central processing units (CPUs), for example. Processor 1401, data storage device 1402, and/or memory 1403 may include, be supplemented by, or incorporated in, one or more application-specific integrated circuits (ASICs) and/or one or more field programmable gate arrays (FPGAs).

Data storage device 1402 and memory 1403 each include a tangible non-transitory computer readable storage medium. Data storage device 1402, and memory 1403, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1405 may include peripherals, such as a printer, scanner, display screen, etc. For example, input/output devices 1405 may include a display device such as a cathode ray tube (CRT) or liquid crystal display (LCD) monitor for displaying information to the user, a keyboard, and a pointing device such as a mouse or a trackball by which the user can provide input to computer 1400.

Any or all of the systems and apparatus discussed herein, including network manager 135, content server 180, messaging service 145, and user device 160, and components thereof, including controller 210, user registration & login module 220, websocket module 225, messaging module 310, and storage 230, may be implemented using a computer such as computer 1400.

One skilled in the art will recognize that an implementation of an actual computer or computer system may have other structures and may contain other components as well, and that FIG. 14 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of providing information, the method comprising:
retrieving from a storage a plurality of messages in response to a request received from a user device, the plurality of stored messages comprising a first message of a first type and a second message of a second type;
causing the user device to display the plurality of messages in a first region of a display;
in response to selections of respective messages from among the plurality of messages, causing the user device to display, simultaneously, the plurality of messages in the first region of the display and content associated with each selected message in a second region of the display.

2. The method of claim 1, wherein:
the first message of the first type comprises a chat message; and
the second message of the second type comprises an email message.

3. The method of claim 1, further comprising:
establishing, by a server, a websocket connection between the server and the user device; and
providing the plurality of messages to the user device via the websocket connection.

4. The method of claim 3, further comprising:
streaming the plurality of messages to the user device via the websocket connection.

5. A method of providing information via a network, the method comprising:
establishing, by a server, a full-duplex communication channel between the server and a user device;
retrieving from a storage a plurality of messages based on a request received from the user device;
providing the plurality of messages to the user device via the full-duplex communication channel;
causing the user device to display the plurality of messages in a first webview;
receiving from the user device, via the full-duplex communication channel, a selection of a particular message among the plurality of messages;
providing to the user device, via the via the full-duplex communication channel, content associated with the particular message; and
causing the user device to display simultaneously the plurality of messages in the first webview and the content in a second webview.

6. The method of claim 5, wherein the full-duplex communication channel comprises a websocket connection.

7. The method of claim 6, further comprising:
receiving a WebSocket handshake request from the user device; and
transmitting to the user device a WebSocket handshake response.

8. The method of claim 7, wherein communications are conducted via the full-duplex communication channel using Transmission Control Protocol (TCP) port 80.

9. The method of claim 5, wherein providing the plurality of messages to the user device via the full-duplex communication channel further comprises:
streaming the plurality of messages to the user device via the full-duplex communication channel.

10. The method of claim 5, further comprising:
receiving from the user device, via the full-duplex communication channel, a second selection of a second particular message among the plurality of messages;
providing to the user device, via the via the full-duplex communication channel, second content associated with the second particular message; and
causing the user device to display simultaneously the plurality of messages in the first webview and the second content in the second webview.

11. A system comprising:
a storage adapted to store a plurality of messages;
a processor adapted to:
establish a full-duplex communication channel between the server and a user device;
retrieve from the storage the plurality of messages based on a request received from the user device;
provide the plurality of messages to the user device via the full-duplex communication channel;
cause the user device to display the plurality of messages in a first webview;
receive from the user device, via the full-duplex communication channel, a selection of a particular message among the plurality of messages;
provide to the user device, via the via the full-duplex communication channel, content associated with the particular message; and
cause the user device to display simultaneously the plurality of messages in the first webview and the content in a second webview.

12. The system of claim 11, wherein the full-duplex communication channel comprises a websocket connection.

13. The system of claim 12, wherein the processor is further adapted to:
receive a WebSocket handshake request from the user device; and
transmit to the user device a WebSocket handshake response.

14. The system of claim 13, wherein communications are conducted via the full-duplex communication channel using Transmission Control Protocol (TCP) port 80.

15. The system of claim 11, wherein the processor is further adapted to:
stream the plurality of messages to the user device via the full-duplex communication channel.
